(19) United States
(12) Patent Application Publication
(10) Pub. No.: US 2007/0262720 A1
(43) Pub. Date: Nov. 15, 2007

(54) High temperature lead-free paint composition for UV-control lamps

(76) Inventors: Deeder Aurongzeb, Mayfield Heights, OH (US); Gerald Schuh, Gates Mills, OH (US); Colin Johnston, Cleveland Heights, OH (US); Selmar Dorsey, Twinsburg, OH (US)

Correspondence Address: Timothy E. Nauman, 7th Floor, 1100 Superior Avenue, Cleveland, OH, 44114-2579, US

(21) Appl. No.: 11/435,004

(22) Filed: May 15, 2006

(51) Int. Cl. H01J 61/35

(52) U.S. Cl. 313/635

(57) ABSTRACT

The present invention relates to a lead free paint composition for use on UV control lamps. The paint composition is able to withstand high application and operating temperatures, up to 800° C., without exhibiting performance or visual degradation. The paint is used to differentiate lamps including a UV protective quartz jacket from similar lamps that lack such protection.

### BACKGROUND OF THE INVENTION

The present disclosure relates to a lead-free paint composition. It finds particular application in conjunction with UV-control lamps, and will be described with particular reference thereto. However, it is to be appreciated that the present disclosure is also amenable to other like applications.

Non-UV control lamps are lamps that are ordinary, in the sense that the lamps emit light in all wavelengths. Non-UV control lamps in the market range in power, or wattage, from 575 W up to 6 KW. Generally, lamps of this wattage are used in those situations demanding more intense lighting, for example in television stations and production studios, or for concerts and live performances. These lamps usually have an outer jacket which is comprised of normal quartz, as is well known in the industry.

Visible light is that light characterized by a wavelength of between 400 nm and 1000 nm. This wavelength requires no protection for the user under normal use conditions. With regard, however, to the emission of ultra-violet light, or UV light, which is that light exhibiting a wavelength of between 150 nm and 400 nm, care must be taken to protect the user or those exposed to such light due to the fact that UV light is potentially harmful to the eyes and skin. In those instances where UV control lamps are employed, the lamps can be prepared with a special outer jacket to control UV light emission. One such outer jacket comprises quartz outer jackets doped with cerium, which in use absorb up to about 80% of the potentially harmful UV emissions from the lamp. With this type of protective jacket in place, the UV control lamp does not pose the same photobiological hazard as does a non-UV control lamp.

Lamps of the type just discussed are available in many different sizes, including lamps, for example, of 575 W, 800 W, 1200 W, 2500 W, 4000 W and 6000 W. These lamps may be provided with or without a protective coating of the type described above. The coating, however, is not discernable to the user. Therefore, one might easily mistake a lamp without a doped outer jacket for one having a doped outer jacket. Such a mistake may result in harmful burns and irritation to the eyes and skin of those exposed to the emissions from the lamp.

Consequently, it has become desirable to develop a manner of differentiating those lamps with and without the doped, protective outer jacket. One such manner is to apply a coating to the base of the lamp that will provide a visible indication of the type of jacket on the lamp being used. However, such a coating to be useful must withstand high operating temperatures, of at least 300° C. In addition, the coating, according to guidelines established in the industry and by government policy with regard to protection of the environment, must be lead-free.

Accordingly, it is desirable to develop a new and improved UV control lamp that accommodates the need of the consumer to be able to differentiate between non-UV control lamps and UV control lamps, this lamp having a manner of differentiation which is easily and economically applied and which withstands application and operating conditions, such as high temperatures, and meets established environmental protection standards.

### BRIEF DESCRIPTION OF THE INVENTION

A UV control lamp is provided. The lamp includes a high temperature coating, or paint, that is applied as an indicator of the use on the lamp of a doped, or other, protective quartz jacket. The doped jacket is disposed such that about 80% of the UV light emission from the lamp is absorbed. The high temperature paint or coating is disposed for ease of detection by the consumer, preferably on the base of the lamp.

The coating, or paint, is a lead-free composition. Therefore, the coating complies with existing directives and standards, set by the industry and by the government agencies which regulate matters impacting the environment and user safety, both in the US and in foreign markets.

In addition to the foregoing, the coating is able to withstand operating temperatures of at least 300° C. without experiencing any detrimental affect, either to lamp or coating performance, or to the integrity of the composition itself.

### DETAILED DESCRIPTION OF THE INVENTION

The invention has been described with reference to the preferred embodiments. Obviously, modifications and alterations will occur to others upon reading and understanding the preceding detailed description. It is intended that the invention be construed as including all such modifications and alterations.

As used herein, “UV controlled lamp” refers to lamps which emit light in all wavelengths, including between 150 nm and 400 nm which is ultra-violet radiation, and which include a manner to protect the user from exposure to such radiation. UV control lamps of anywhere from 575 W to 6000 W may be protected, for example, by the application of a doped quartz jacket, formulated to specifically address the emission of UV light by absorbing the same.

As used herein, “paint” and “coating” and the various forms thereof are used interchangeably to refer to the composition used in keeping with the invention to identify UV control lamps.

While the coating composition disclosed herein may be applicable to many types of lamps, it is described herein with reference to lamps that operate at anywhere from 575 W to 6 KW, including but not limited to 575 W, 800 W, 1200 W, 2500 W, 4000 W and 6000 W, and which emit light in all wavelengths. The coating composition is used specifically to identify easily to the consumer or user those lamps having a doped jacket, and thus capable of use for extended periods of time with little or no detrimental affect to those exposed to the emissions from the lamps. Of course, the coating may find application in any lamp product where it is desirable to differentiate the lamp from another of the same type.

The coating composition is applied directly to the base of the lamp. This may be accomplished by any suitable method, including as part of the lamp production process, by post-production methods or even by hand. The composition contains nothing that is environmental hazardous, either in application or in use. The lamp base may be any of several commonly used in the industry, including but not limited to those comprising alumina, zircon-cordierite, and steatite. In general, the lamp-base temperature is rated less than 300° C., corresponding to a use limit of the same temperature. The coating compositions disclosed herein, which comprise lead-free paint, can withstand temperatures of up to and greater than 400° C.

The coating composition may take the form of paint or a paste-like consistency, among other forms. The form used may depend on the operating temperatures to which the coating will be subjected. For very high application and/or operating temperatures, the paste, also referred to as a sticker, may be more advantageous due to the actual components and the ability thereof to maintain integrity at temperatures in excess of 400° C., up to 800° C.

In that instance where the coating takes the form of a paste, the coating is formulated to include the components shown in Table I according to the provided ranges. The process used to formulate the coating is similar to the standard industrial process.

Specifically, the inorganic components of the coating composition are mixed according to the ratios provided in Table I. This mixture is melted in a firing chamber at temperatures in excess of 1100° C. Once melted, the composition is poured immediately into water to obtain a glassy, flaked material. This flaked material is then added to a ball mill and is ground into a micron sized powder. The powder thus prepared is then mixed with an organic solvent at a mixing ratio of at least 30% by weight of the total weight of the mixture. This solvent may be any standard industrial solvent prepared from a flammable resin, such as methacrylate, cellulose, or other known resins of this type, combined with a solvent such as pine oil, terpineol, or other similar organic solvent. Combination of the resin/organic solvent with the glassy, flaked material containing the coating components results in a composition with the consistency of a paste.

The paste rendered by the above mixing/grinding/mixing process is then applied by any conventional means to the base of the lamp. The lamp base is heat treated at temperatures in excess of 800° C. for at least 30 minutes. At this temperature, the organic solvent is dissolved and the remaining powder binds to the base of the lamp. Alternatively, the coating composition may be applied directly to a ceramic lamp base and heat-treated at temperatures in excess of 800° C. to bind the coating to the lamp base.

The SiO₂ component of the coating composition is added as a filler material to enhance the oxide network and the structural integrity of the coating composition. Alternatively, a material such as HfO₂ may be added to render the coating more robust. While the composition shown in Table I results in a dark blue colored coating, the coloring may be lightened by the addition of, for example, from about 2% to about 10% indium oxide as part of the filler material component.

The coating composition, prepared in accord with the foregoing processing, and which withstands temperatures of up to 800° C., was applied in the form of a paste, or sticker, to a 6 KW UV control lamp. The paint was observed to bind to the lamp base without experiencing any degradation.

TABLE I
HIGH TEMPERATURE LEAD FREE STICKER

| COMPONENT | RANGE OF CONTENT (%) |
|---|---|
| SiO₂ | 20.0-30.0% |
| B₂O₃ | 15.0-40.0% |
| Al₂O₃ | 5.0-20.0% |
| ZnO | 5.0-10.0% |
| CoO | 3.0-5.0% |
| Cr₂O₃ | 1.0-5.0% |
| NiO | <1.0% |
| Organic solvent | >30.0% |

For UV control lamps with wattage of 575 W, 800 W, 1200 W, 2500 W and 4000 W, the paint composition disclosed below in Table II was employed. The coating, or paint, was tested to withstand temperatures of up to 500° C. This coating composition was prepared in accord with the processing set forth above with regard to the composition provided in Table I. However, this composition included several solvents, which rendered the coating in the form of a more conventional paint. The solvents used in this paint composition would be likely to dissociate, or evaporate, at the higher temperature experienced by the paste set forth in Table I, but remain stable at the lower temperature parameters for this paint, i.e., 500° C., which is nonetheless a higher temperature per the industry standard set for the operation of this type of lamp.

TABLE II
HIGH TEMPERATURE LEAD FREE PAINT

| COMPONENT | RANGE OF CONTENT (%) |
|---|---|
| SiO₂ | >30.0% |
| Titanium Oxide | 2.0-10.0% |
| CoO | 3.0-10% |
| Cr₂O₃ | 1.0-2.0% |
| ZnO | <1.0% |
| Toluene | 8.0-9.0% |
| Methanol | 7.0-8.0% |
| Isopropyl Alcohol | 20.0-25.0% |
| Ethylene Glycol | |
| Monobutyl Ether | 7.0-8.0% |

While the coating composition may be rendered in any color to make it discernable to the user, the foregoing coatings were formulated to render a blue composition. This color is attributed to inclusion of the cobalt compound. Other colors may be achieved by the addition of other compounds known to the skilled artisan, though the compound should be chosen carefully so as not to affect the temperature performance of the coating.

The coatings were evaluated to establish that they were heat proof, shown by maintenance of the original color of the coating, both through application at very high temperature and then under operating conditions. Table III below provides data of this evaluation.

TABLE III
EVALUATION OF COATINGS

| | BASE | | |
|---|---|---|---|
| LAMP | MATERIAL | FORM | EVALUATION |
| 6 KW/UVC* | Steatite | sticker | fixed at 800° C.**; |
| | | | result: no color change |
| 1200 W/UVC* | Zircon- | paint | base only test: |
| (Continued) | cordierite | | |
| 2500 W/UVC* | | | 500° C./10 hrs. + |
| | | | 400° C./70 hrs. |
| 4000 W/UVC* | | | result: OK |
| | | | lamp (4 KW) test: |
| | | | 100 hrs in fixture |
| | | | result: OK |
| 575 W/UVC* | Alumina | sticker | fixed at 800° C.**; |
| | | | result: OK |
| 800 W/UVC* | Alumina | paint | test: |
| | | | 500° C./100 hrs |
| | | | result: OK |

Additional testing was performed to establish the integrity of the coating in use. The test used was a thermal shock test, during which the lamps specified in the tables above, bearing the coating according to the invention, were operated at 800° C. for 20 hours. At the end of this time, the lamps, in the hot condition, were dropped into water having a temperature of 27° C., i.e., subjected to extreme thermal shock. In all cases the coatings upon evaluation showed no sign of degradation.

Although the present disclosure has been described with regard to UV control lamps, it will be understood that the disclosure also finds application in any situation where it is necessary or desirable to differentiate lamps which otherwise appear the same. This is especially true in those circumstances requiring high temperature performance characteristics.

The invention has been described with reference to the preferred embodiments. Obviously, modifications and alterations will occur to others upon reading and understanding the preceding detailed description. It is intended that the invention be construed as including all such modifications and alterations.

The invention has been described with reference to the preferred embodiments. Obviously, modifications and alterations will occur to others upon reading and understanding the preceding detailed description. It is intended that the invention be construed as including all such modifications and alterations.

What is claimed is:

1. A coating for ultraviolet control lamps comprising:
a lead-free coating composition containing oxides exhibiting high temperature performance characteristics such that the integrity of the coating is maintained at temperatures above 400° C.

2. The coating according to claim 1, wherein said lead-free coating composition is in the form of a sticker.

3. The coating according to claim 1, wherein said lead-free coating composition is a paint.

4. The coating according to claim 1, wherein said oxides are selected from the group consisting of oxides of boron, aluminum, zinc, cobalt, titanium and chromium.

5. The coating according to claim 4, wherein said coating comprises B₂O₃, Al₂O₃, ZnO, CoO, and Cr₂O₃, and is in the form of a sticker.

6. The coating according to claim 4, wherein said coating is a paint comprising TiO, CoO, Cr₂O₃, and at least one solvent.

7. The coating according to claim 1, wherein said coating is applied to the base of a UV control lamp.

8. The coating according to claim 7, wherein said coating is applied to said base of said lamp at a temperature of up to 800° C.

9. The coating according to claim 1, wherein said coating is blue.

10. A UV control lamp comprising a lamp with a wattage of between 500 W and 6000 W, and emitting all wavelengths of light including UV radiation with a wavelength between 150 nm and 400 nm, said lamp including a protective quartz jacket, that absorbs up to 80% of the UV radiation emitted by said lamp, and said lamp including a high temperature performance coating as an indicator that said lamp includes said UV protective jacket.

11. The UV control lamp according to claim 10, wherein said high temperature performance coating is located on the base of said lamp.

12. The UV control lamp according to claim 10, wherein said high temperature performance coating is a lead-free coating composition containing oxides exhibiting high temperature performance characteristics such that the integrity of the coating is maintained at temperatures above 400° C.

13. The UV control lamp according to claim 12, wherein said lead-free coating composition is in the form of a sticker.

14. The UV control lamp according to claim 12, wherein said lead-free coating composition is a paint.

15. The UV control lamp according to claim 12, wherein said oxides are selected from the group consisting of oxides of boron, aluminum, zinc, cobalt, titanium and chromium.

16. The UV control lamp according to claim 15, wherein said coating comprises B₂O₃, Al₂O₃, ZnO, CoO, and Cr₂O₃, and is in the form of a sticker.

17. The UV control lamp according to claim 15, wherein said coating is a paint comprising TiO, CoO; Cr₂O₃, and at least one solvent.

18. The UV control lamp according to claim 11, wherein said coating is applied to said base of said lamp at a temperature of up to 800° C.

19. The UV control lamp according to claim 10, wherein said coating is blue.
